(19) United States
(12) Patent Application Publication
(10) Pub. No.: US 2003/0062493 A1
(43) Pub. Date: Apr. 3, 2003

(54) Self-adjusting gas valve and device using the valve

(76) Inventor: Hwai-Tay Lin, Road Town (VG)

Correspondence Address: Alan D. Kamrath, Rider, Bennett, Egan & Arundel, LLP, Suite 2000, 333 South Seventh Street, Minneapolis, MN, 55402, US

(21) Appl. No.: 09/968,639

(22) Filed: Oct. 1, 2001

(51) Int. Cl. F16K 25/00

(52) U.S. Cl. 251/84

(57) ABSTRACT

A self-adjusting gas valve comprises a valve seat including an outlet passage. An adjusting rod comprises an end received in the valve seat such that the adjusting rod moves along a longitudinal axis thereof when it is turned. A control member comprises a first end engaged with the second end of the adjusting rod and a second end received in an inlet end of the outlet passage. The second end of the control member is moved along a longitudinal axis of the outlet passage to thereby control opening and closing of the inlet end of the outlet passage when the adjusting rod is turned. The first end of the control member is pivotable relative to the second end of the adjusting rod to completely block the inlet end of the outlet passage when the control member is moved to a closed position.

### BACKGROUND OF THE INVENTION

1. Field of the Invention

The present invention relates to a self-adjusting gas valve and a device using the self-adjusting gas valve, such as a torch.

2. Description of the Related Art

Gas adjusting valves are widely used to adjust and thus control the flow of gas. FIG. 1 of the drawings illustrates a conventional adjusting valve for a torch. The adjusting valve comprises a valve body 1 having an inlet passage 2 and an outlet passage 3. Inflammable gas enters the inlet passage 2 and then exits the valve body 1 via the outlet passage 3. A cone 5 of an adjusting stem 4 is received in the outlet passage 3 of the valve body 1. When fine adjustment in the flow of gas is required, the adjusting stem 4 is turned to adjust a gap between the cone 5 and an inner periphery defining the outlet passage 3. The cone 5 is integrally formed with the adjusting stem 4 and thus requires high-precision processing. The cost is, of course, high, and the ratio of bad products/good products is also high. In addition, the cone 5 is rigid and thus incapable of providing the required sealing function when a complete blocking effect cannot be obtained between the cone 5 and the inner periphery of the outlet passage 3 due to tolerance. Precision control of the flow of the gas passing through the outlet passage 3 cannot be obtained. Further, the whole adjusting stem 4 must be made from temperature-resistant and abrasion-resistant material, as the cone 5 is in long-term contact with high-temperature flame. This inevitably increases the difficulty of and the cost for processing of the adjusting stem 4 having the cone 5.

### SUMMARY OF THE INVENTION

An object of the present invention is to provide a self-adjusting gas valve comprising:

a valve seat comprising a compartment in a first end thereof and an outlet passage in a second end thereof, the outlet passage being communicated with the compartment and comprising an inlet end adjacent to the compartment and an outlet end distal to the compartment, the valve seat further comprising an inlet passage communicated with the inlet end of the outlet passage;

an adjusting rod comprising a first end and a second end that is received in the compartment of the valve seat, the adjusting rod being engaged in the compartment of the valve seat in a manner that the adjusting rod moves along a longitudinal axis thereof when it is turned; and

a control member comprising a first end engaged with the second end of the adjusting rod and a second end received in the inlet end of the outlet passage, the second end of the control member being moved along a longitudinal axis of the outlet passage to thereby control opening and closing of the inlet end of the outlet passage when the adjusting rod is turned, and the first end of the control member being pivotable relative to the second end of the adjusting rod to completely block the inlet end of the outlet passage when the control member is moved to a closed position.

The present invention also provides a device such as a torch that uses the self-adjusting gas valve. The device comprises:

a chamber and a head communicated with the chamber, an ignition means and a coupler being mounted in the head;

a valve seat received in the head, the valve seat comprising a compartment in a first end thereof and an outlet passage in a second end thereof, the outlet passage being communicated with the compartment and comprising an inlet end adjacent to the compartment and an outlet end distal to the compartment, the valve seat further comprising an inlet passage communicated with the inlet end of the outlet passage and the chamber;

an adjusting rod comprising a first end and a second end that is received in the compartment of the valve seat, the adjusting rod being engaged in the compartment of the valve seat in a manner that the adjusting rod moves along a longitudinal axis thereof when it is turned;

a knob mounted to the first end of the adjusting rod to rotate therewith, the knob being slidable relative to the adjusting rod to activate the ignition means; and

a control member comprising a first end engaged with the second end of the adjusting rod and a second end received in the inlet end of the outlet passage, the second end of the control member being moved along a longitudinal axis of the outlet passage to thereby control opening and closing of the inlet end of the outlet passage when the knob is turned, and the first end of the control member being pivotable relative to the second end of the adjusting rod to completely block the inlet end of the outlet passage when the control member is moved to a closed position.

The inlet end of the outlet passage comprises an inner periphery that tapers toward the outlet end of the outlet passage. The second end of the control member tapers corresponding to tapering of the inlet end of the outlet passage. The adjusting rod comprises an outer threading, and an inner periphery defining the compartment of the valve seat comprises an inner threading for threading engagement with the outer threading of the adjusting rod. The second end of the adjusting rod comprises a receptacle in an end face thereof for retaining the first end of the control member while allowing pivotal movement of the first end of the control member in the receptacle. The control member is made of temperature-resistant material and the adjusting rod is made of ordinary metal. In assembly, the first end of the control member is placed in the receptacle of the second end of the adjusting rod, and an external force is then applied to deform an outer wall defining the receptacle of the adjusting rod to thereby retain the control member in place, yet pivotal movement of the first end of the control member relative to the second end of the adjusting rod is allowed. The first end of the control member and an inner periphery defining the receptacle are both preferably spherical.

Other objects, advantages, and novel features of the invention will become more apparent from the following detailed description when taken in conjunction with the accompanying drawings.

### BRIEF DESCRIPTION OF THE DRAWINGS

FIG. 1 is a sectional view of a conventional torch.

FIG. 2 is an exploded perspective view of a self-adjusting gas valve in accordance with the present invention.

FIG. 3 is a sectional view of the self-adjusting gas valve in accordance with the present invention.

FIG. 4A is a sectional view, in an enlarged scale, of an adjusting stem and a control member of the self-adjusting gas valve before assembly.

FIG. 4B is a sectional view, in an enlarged scale, of the adjusting stem and the control member after assembly.

FIG. 5 is a side view, partly sectioned, of a torch using the self-adjusting gas valve in accordance with the present invention.

FIG. 6 is an enlarged view of a circled portion in FIG. 5, illustrating self-adjustment of the control member.

FIG. 7 is a sectional view similar to FIG. 6, wherein the control member is in a closed position.

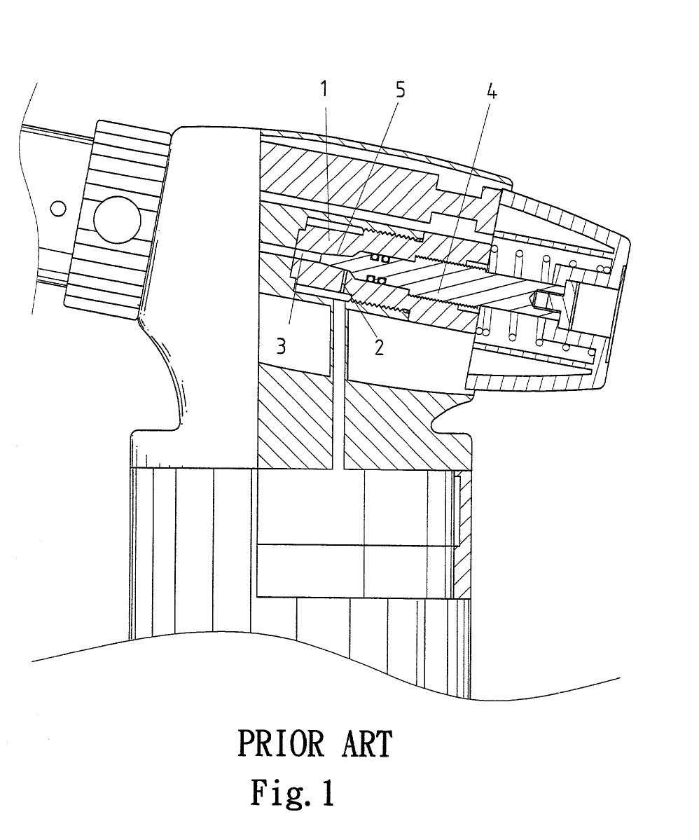

### DETAILED DESCRIPTION OF THE PREFERRED EMBODIMENT

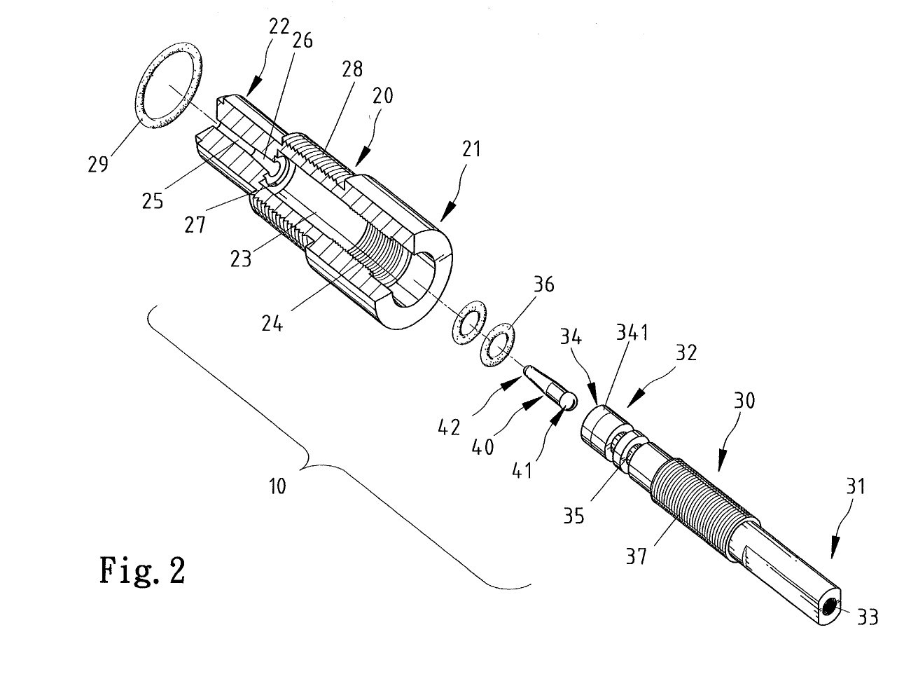

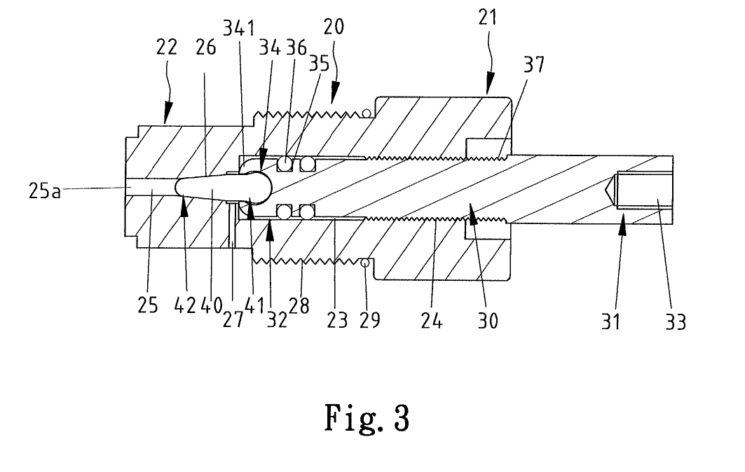

Referring to FIGS. 2 through 7 and initially to FIGS. 2 and 3, a self-adjusting gas valve 10 in accordance with the present invention generally comprises a valve seat 20, an adjusting rod 30, and a control member 40 that may pivot relative to the adjusting rod 30 to thereby provide a self-adjusting function.

The valve seat 20 has a first end 21 in which an outlet 25 is defined and a second end 22 having an inner threading 24. The valve seat 20 further comprises a compartment 23 communicating with the outlet passage 25, the inner threading 24 being defined in an inner periphery defining the compartment 23. Further, the valve seat 20 further has an outer threading 28 in an outer periphery thereof. An O-ring 29 is mounted around the outer periphery of the valve seat 20 to provide required sealing when the valve seat 20 is engaged in another element. The valve seat 20 further comprises a transverse inlet passage 27 communicated with an inlet end 26 of the outlet passage 25 that is adjacent to the compartment 23 of the valve seat 20. The inlet end 26 of the outlet passage 25 is configured to taper toward an outlet end 25a of the outlet passage 25 opposite to the inlet end 26, as shown in FIGS. 2 and 3.

The adjusting rod 30 is made of ordinary metal and includes a first end 31 and a second end 32. A screw hole 33 is defined in an end face of the first end 31 of the adjusting rod 30. A receptacle 34 is defined in an end face of the second end 32 of the adjusting rod 30. An outer threading 37 is defined in an outer periphery of the adjusting rod 30 for threading engagement with the inner threading 24 of the valve seat 20. Two O-rings 36 are respectively received in two annular grooves 35 that are defined in the outer periphery of the adjusting rod 30 adjacent to the second end 32 of the adjusting rod 30. As illustrated in FIG. 3, the second end 32 of the adjusting rod 30 is threadedly engaged in the compartment 23 of the valve seat 20 with the second end 32 of the adjusting rod 30 abutting against the inlet end 26 of the outlet passage 25 of the valve seat 20. The O-rings 36 provide desired sealing. When the adjusting rod 30 is turned, it is moved along a longitudinal direction of the valve seat 20 due to threading engagement between the inner threading 24 of the valve seat 20 and the outer threading 37 of the adjusting rod 30.

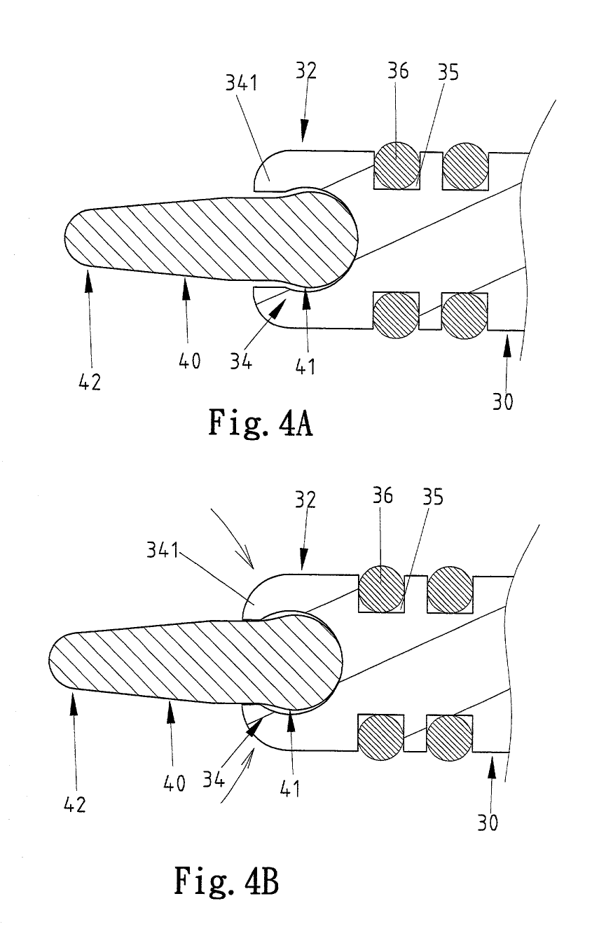

The control member 40 is made of temperature-resistant material (such as a material containing high percentage of steel) and comprises a first end 41 and a second end 42. In assembly, referring to FIG. 4A, the first end 41 of the control member 40 is placed in the receptacle 34 of the second end 32 of the adjusting rod 30. Next, an external force is applied to deform an outer wall 341 defining the receptacle 34 of the adjusting rod 30 to thereby retain the control member 40 in place, yet pivotal movement of the first end 41 of the control member 40 relative to the second end 32 of the adjusting rod 30 is allowed. The first end 41 of the control member 40 and an inner periphery defining the receptacle 34 are both preferably spherical. The second end 42 of the control member 40 is tapered in a manner corresponding to the tapering of the inlet end 26 of the outlet passage 25. Thus, the control member 40 may be moved along a longitudinal direction of the outlet passage 25 by means of turning the adjusting rod 30 to thereby selectively close or open the outlet passage 25.

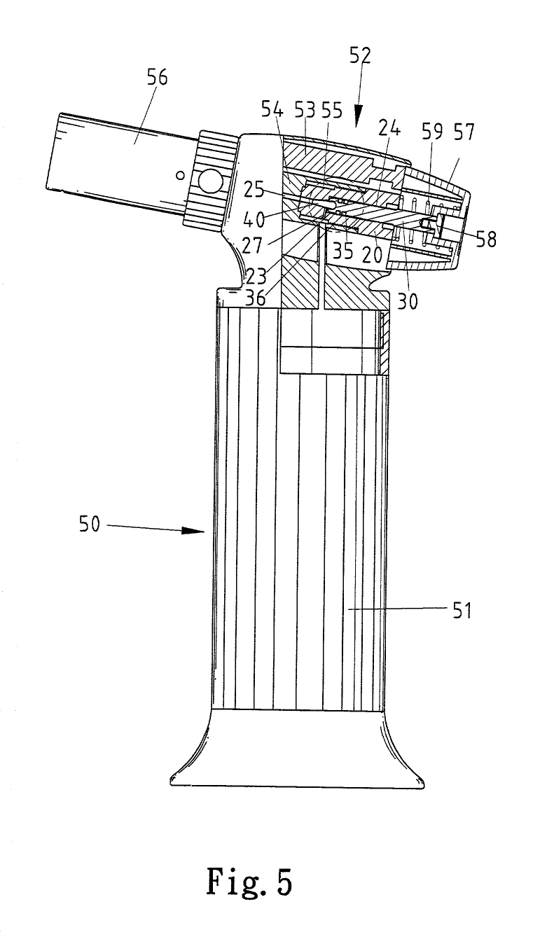

FIG. 5 illustrates a torch 50 using the self-adjusting gas valve 10 in accordance with the present invention. The torch 50 comprises a chamber 51 for supplying inflammable gas and a head 52 communicated with the chamber 51. An ignition means 53 and a coupler 54 are mounted in the head 52. The coupler 54 comprises a compartment 55 for threading engagement with the outer threading 28 of the valve seat 20 such that the inlet passage 27 of the valve seat 20 is communicated with the chamber 51 and that the outlet passage 25 of the valve seat 20 is communicated with a nozzle 56 of the torch 50. A bolt 58 is threadedly engaged in the screw hole 33 of the adjusting rod 33 to mount a knob 57 to the first end 31 of the adjusting rod 30 without the risk of disengagement of the knob 57 from the adjusting rod 30. In this embodiment, the knob 57 and the first end 31 of the adjusting rod 30 both have a non-circular section to allow joint rotation while allowing movement of the knob 57 relative to the adjusting rod 30 along a longitudinal axis of the adjusting rod 30. An elastic element 59 is attached between the knob 57 and the adjusting rod 30 for returning the knob 57 to its initial position.

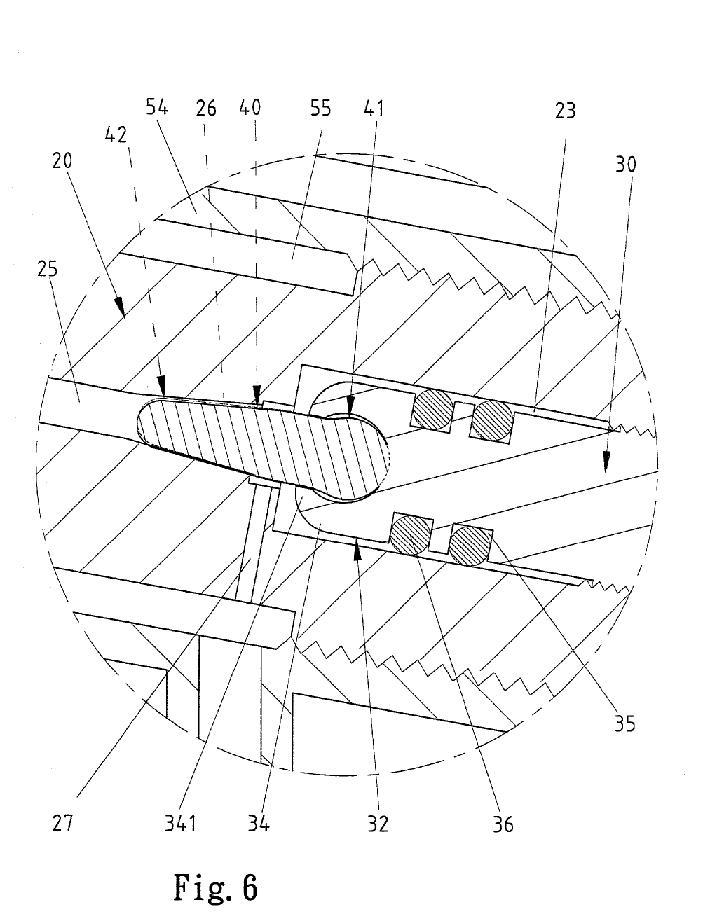

In use, referring to FIG. 6, when adjusting the flow of gas in the outlet passage 25, the knob 57 is turned to cause longitudinal movement of the adjusting rod 30 and the control member 40. The position of the control member 40 relative to an inner periphery defining the inlet end 26 of the outlet passage 25 is thus varied until a desired gas flow is obtained. Next, the knob 57 can be pushed inward to thereby activate the ignition means 53 for inflaming the gas from the outlet passage 25 and thus outputting flame via the nozzle 56. Thus, the torch 50 can be used to proceed with required function. It is noted that the first end 41 of the control member 40 may pivot relative to the second end 32 of the adjusting rod 30, a self-adjusting function is thus provided while precisely controlling the flow of the gas. The difficulty in precise control of the flow of gas as a result of an error or resulting from processing can be avoided.

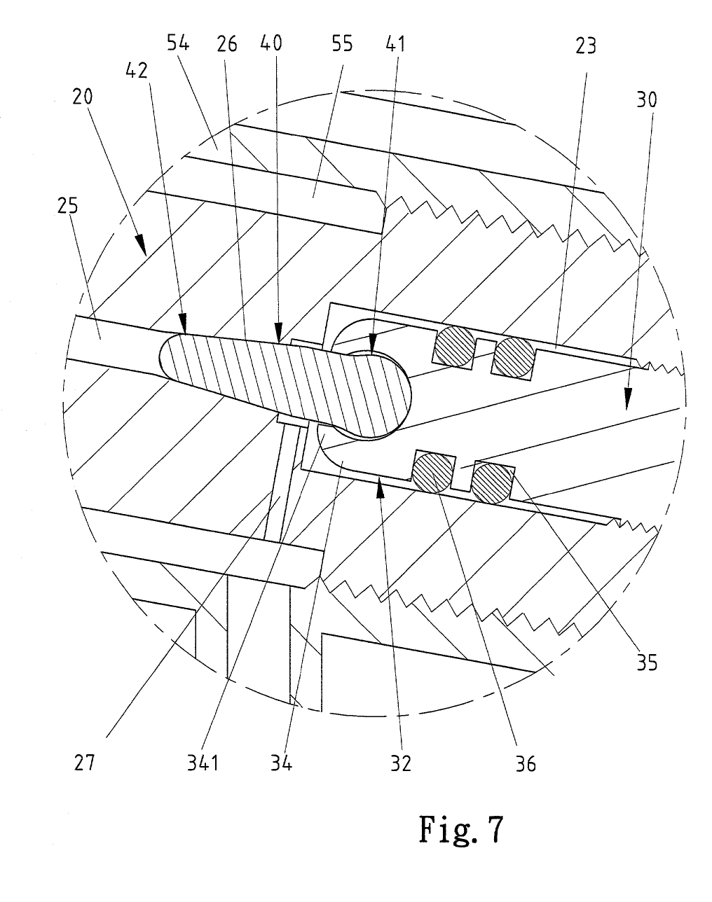

Referring to FIG. 7, when turning off the torch 50, the knob 57 is turned to move the adjusting rod 30 and the control member 40 toward the outlet end 25a of the outlet passage 25 until the tapered inlet end 26 of the outlet passage 25 is completely blocked by the tapered second end 42 of the control member 40. The pivotal movement between the first end 41 of the control member 40 and the second end 32 of the adjusting rod 30 assures reliable blockage of the inlet end 26 of the outlet passage 25. Thus, it is impossible for the gas from the inlet passage 27 to leak via the outlet passage 25. The control member 40 is made of temperature-resistant material, as it has to be in long-term contact with high-temperature flame. But the adjusting rod 30 can be made of ordinary metal. The difficulty of and cost for processing the adjusting rod 30 and the control member 40 is largely reduced.

Although the invention has been explained in relation to its preferred embodiment, it is to be understood that many other possible modifications and variations can be made without departing from the scope of the invention as hereinafter claimed.

What is claimed is:

1. A self-adjusting gas valve comprising:
a valve seat comprising a compartment in a first end thereof and an outlet passage in a second end thereof, the outlet passage being communicated with the compartment and comprising an inlet end adjacent to the compartment and an outlet end distal to the compartment, the valve seat further comprising an inlet passage communicated with the inlet end of the outlet passage;
an adjusting rod comprising a first end and a second end that is received in the compartment of the valve seat, the adjusting rod being engaged in the compartment of the valve seat in a manner that the adjusting rod moves along a longitudinal axis thereof when it is turned; and
a control member comprising a first end engaged with the second end of the adjusting rod and a second end received in the inlet end of the outlet passage, the second end of the control member being moved along a longitudinal axis of the outlet passage to thereby control opening and closing of the inlet end of the outlet passage when the adjusting rod is turned, and the first end of the control member being pivotable relative to the second end of the adjusting rod to completely block the inlet end of the outlet passage when the control member is moved to a closed position.

2. The self-adjusting gas valve as claimed in claim 1, wherein the inlet end of the outlet passage comprises an inner periphery that tapers toward the outlet end of the outlet passage.

3. The self-adjusting gas valve as claimed in claim 2, wherein the second end of the control member tapers corresponding to tapering of the inlet end of the outlet passage.

4. The self-adjusting gas valve as claimed in claim 1, wherein the adjusting rod comprises an outer threading, an inner periphery defining the compartment of the valve seat comprising an inner threading for threading engagement with the outer threading of the adjusting rod.

5. The self-adjusting gas valve as claimed in claim 1, wherein the second end of the adjusting rod comprises a receptacle in an end face thereof for retaining the first end of the control member while allowing pivotal movement of the first end of the control member in the receptacle.

6. The self-adjusting gas valve as claimed in claim 1, wherein the control member is made of temperature-resistant material and the adjusting rod is made of ordinary metal.

7. The self-adjusting gas valve as claimed in claim 1, wherein in assembly, the first end of the control member is placed in the receptacle of the second end of the adjusting rod, and an external force is then applied to deform an outer wall defining the receptacle of the adjusting rod to thereby retain the control member in place, yet pivotal movement of the first end of the control member relative to the second end of the adjusting rod is allowed.

8. The self-adjusting gas valve as claimed in claim 1, wherein the first end of the control member and an inner periphery defining the receptacle are both preferably spherical.

9. A device comprising:
a chamber and a head communicated with the chamber, an ignition means and a coupler being mounted in the head;
a valve seat received in the head, the valve seat comprising a compartment in a first end thereof and an outlet passage in a second end thereof, the outlet passage being communicated with the compartment and comprising an inlet end adjacent to the compartment and an outlet end distal to the compartment, the valve seat further comprising an inlet passage communicated with the inlet end of the outlet passage and the chamber;
an adjusting rod comprising a first end and a second end that is received in the compartment of the valve seat, the adjusting rod being engaged in the compartment of the valve seat in a manner that the adjusting rod moves along a longitudinal axis thereof when it is turned;
a knob mounted to the first end of the adjusting rod to rotate therewith, the knob being slidable relative to the adjusting rod to activate the ignition means; and
a control member comprising a first end engaged with the second end of the adjusting rod and a second end received in the inlet end of the outlet passage, the second end of the control member being moved along a longitudinal axis of the outlet passage to thereby control opening and closing of the inlet end of the outlet passage when the knob is turned, and the first end of the control member being pivotable relative to the second end of the adjusting rod to completely block the inlet end of the outlet passage when the control member is moved to a closed position.

10. The device as claimed in claim 9, wherein the inlet end of the outlet passage comprises an inner periphery that tapers toward the outlet end of the outlet passage.

11. The device as claimed in claim 10, wherein the second end of the control member tapers corresponding to tapering of the inlet end of the outlet passage.

12. The device as claimed in claim 9, wherein the adjusting rod comprises an outer threading, an inner periphery defining the compartment of the valve seat comprising an inner threading for threading engagement with the outer threading of the adjusting rod.

13. The device as claimed in claim 9, wherein the second end of the adjusting rod comprises a receptacle in an end face thereof for retaining the first end of the control member while allowing pivotal movement of the first end of the control member in the receptacle.

14. The device as claimed in claim 9, wherein the control member is made of temperature-resistant material and the adjusting rod is made of ordinary metal.

15. The device as claimed in claim 9, wherein in assembly, the first end of the control member is placed in the receptacle of the second end of the adjusting rod, and an external force is then applied to deform an outer wall defining the receptacle of the adjusting rod to thereby retain the control member in place, yet pivotal movement of the first end of the control member relative to the second end of the adjusting rod is allowed.

16. The device as claimed in claim 9, wherein the first end of the control member and an inner periphery defining the receptacle are both preferably spherical.
